(19) United States
(12) Patent Application Publication
(10) Pub. No.: US 2005/0077213 A1
(43) Pub. Date: Apr. 14, 2005

(54) Vibrating grid shaft assembly

(76) Inventors: Patrick Joseph Douglas, Castletown Isle of Man (GB); Mary Kathleen Douglas, Castletown (GB)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/490,899

(22) PCT Filed: Sep. 25, 2002
(86) PCT No.: PCT/GB02/04336

(30) Foreign Application Priority Data
Sep. 26, 2001 (GB) 0123042.4

(51) Int. Cl. B07B 1/28

(52) U.S. Cl. 209/315

(57) ABSTRACT

A vibrating grid shaft assembly for use in a screening plant having opposed screen frame sides, and which includes a shaft intended to extend between the frame sides, stubshafts projecting from each end of the shaft, and each adapted to be mounted in or on a respective screen frame side, a respective bearing mounted on each stubshaft intended to be located inboard of the adjacent screen frame side, and defining a rotational axis for the shaft, and a respective load mounted eccentrically with respect to the rotational axis and incorporated within the shaft adjacent to each stubshaft and so as to be located inboard of the adjacent screen frame side.

This invention relates to a vibrating grid shaft assembly which is operative to apply vibrational energy to the frame sides of a vibrating grid in order to assist the screening process.

It is well known to use vibrating grids in order to screen a bulk supply of raw material into at least two ranges of size of screened material. In the quarrying industry, the bulk supply of raw material is crushed stone, and the vibrating grids are usually known as “screen boxes”.

In the case of a single deck screen, bulk material can be separated into (a) oversized material (which is too large to move downwardly through the screen apertures and which is discharged to a stockpile, or may be recycled for a further crushing operation), and (b) screened material smaller in size than the screen apertures and which is routed to a separate stockpile.

In the case of a twin deck screen, the material which passes through the upper screen deck falls onto a lower screen deck where further screening takes place, so that three different size ranges of material can be obtained.

A screen deck usually has a small slope, and bulk material is deposited at or near to the upper end of at least the upper deck, and gravity action assists the movement of the bulk material lengthwise of the deck while screening takes place. However, to assist the screening action, it is usual to apply vibrational energy to the frame sides, or chassis, of the screen box, and this can be provided by a rotating shaft assembly which extends between the frame sides, and which carries eccentric masses which apply substantial vibrational forces to the frame sides as the shaft rotates.

It is usual to mount eccentric masses on the projecting outer ends of the shaft, and the out of balance rotational forces generated are then transmitted to the frame sides via the mountings by which the shaft is mounted on the frame sides.

The mountings usually include roller bearings which mount projecting ends or stubshafts of the shaft in the frame sides.

However, although externally mounted eccentric masses work well in practice, there are at least two problems connected with such arrangements. First of all, there is a safety issue in that large masses are being rotated (externally of the screen box) which generate substantial inertia, and care must be taken to shield operatives from exposure to this. Secondly, the presence of eccentric loads externally of the frame sides means that a free circular path of movement for the loads must be made available, and this applies constraints to the way in which adjacent components of the screen are assembled.

The present invention therefore seeks to provide a novel vibrating shaft assembly for a screening plant, and which is effective and also avoids requirement to mount eccentric loads externally of the frame sides of the plant.

According to the invention there is provided a vibrating grid shaft assembly for use in a screening plant having opposed screen frame sides, and which comprises:
a shaft which is intended to extend between the frame sides;
stubshafts projecting from each end of the shaft, and each adapted to be mounted in or on a respective screen frame side;
a respective bearing mounted on each stubshaft and intended to be located inboard of the adjacent screen frame side, and defining a rotational axis for the shaft; and,
a respective load mounted eccentrically with respect to the rotational axis and incorporated within the shaft adjacent to each stubshaft and so as to be located inboard of the adjacent screen frame side.

The invention therefore provides a vibrating grid shaft assembly which no longer requires eccentric masses to be located externally or outboard of the screen frame sides, but which is still able to apply effective vibrational energy to the screen frame sides.

Conveniently, to further protect operatives from exposure to the rotating masses, a stationary protective tube may surround the shaft and mount the bearings in order to mount the shaft for rotation therein. The protective tube may then be capable of being mounted securely at each end on the frame sides, and thereby transmit the vibrational energy to the frame sides.

Each eccentric mass may comprise a cylindrical portion mounted off-set with respect to the rotational axis of the shaft, and a radially projecting counterweight.

The bearings are preferably roller bearings, mounted on the stubshafts at an axial location such that, when the shaft is mounted between the screen frame sides, each bearing is located closely adjacent to the respective screen frame side.

One of the stubshafts may project to a greater extent, so that a hydraulic or other drive motor and associated coupling may be mounted thereon.

A vibrating grid shaft assembly according to the invention may be incorporated in a single, tandem or even multi-deck screen box or other types of screening plants.

A preferred embodiment of vibrating grid shaft assembly according to the invention will now be described in detail, by way of example only, with reference to the accompanying drawings, in which:

FIG. 1 is a side view of the vibrating grid shaft assembly, extending between opposed screen frame sides of a single or multi-deck screening plant such as a “screen box”;

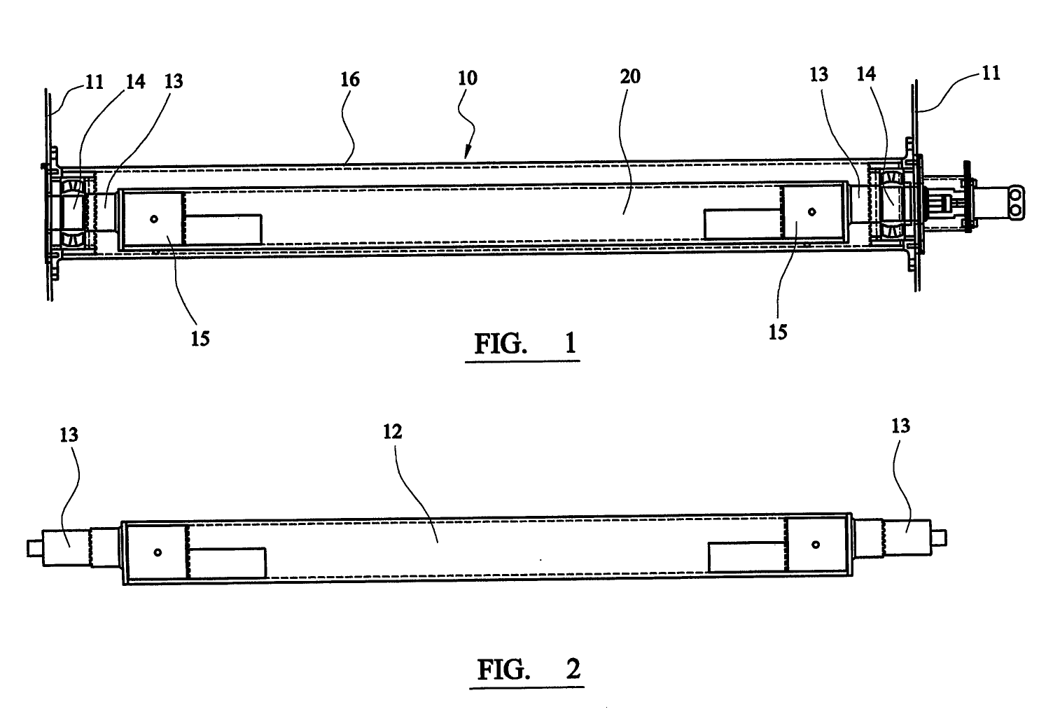

FIG. 2 is a side view of an eccentric shaft assembly of the arrangement shown in FIG. 1;

FIG. 3 is a detail view of an eccentric stubshaft assembly to be provided at each end of the shaft;

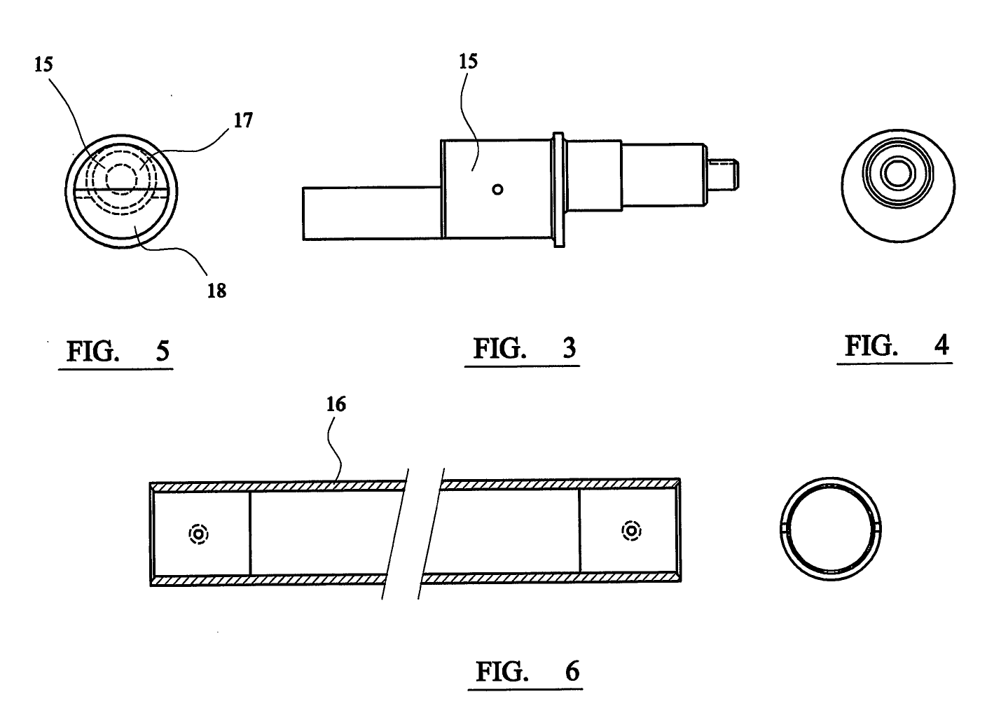

FIG. 4 is a view from one end of the eccentric stubshaft of FIG. 3;

FIG. 5 is a view from the opposite end; and,

FIG. 6 is a side view of an external protective tube surrounding the shaft assembly of FIG. 2, to complete the assembly shown in FIG. 1.

Referring now to the drawings, a vibrating grid shaft assembly according to the invention is designated generally by reference 10, and is intended for use in a screening plant e.g. a single or multi-deck screen box, having opposed screen frame sides, parts of which are shown by reference 11. The assembly 10 comprises a shaft 12 which extends between the frame sides 11, and which has projecting ends in the form of stubshafts 13, each adapted to be mounted in a respective screen frame side 11. A respective bearing 14, preferably a roller bearing, is mounted on each stubshaft 13 and is intended to be located inboard of the adjacent screen frame side 11, and the bearings 14 together define a rotational axis 20 for the shaft 12.

A respective load 15, mounted eccentrically with respect to the rotational axis 20, is incorporated within the shaft 12 adjacent to each stubshaft 13, and so as to be located inboard of the adjacent screen frame side 11. To protect operatives from exposure to the rotating masses, a stationary protective tube 16 surrounds the shaft 12, and also mounts the roller bearings 14 in order to mount the shaft 12 for rotation therein. The protective tube 16 is also capable of being mounted securely at each end on the frame sides 11, and thereby transmits the vibrational energy to the frame sides.

Each eccentric load or mass 15 comprises a cylindrical portion 17 which is off-set with respect to the rotational axis 20 of the shaft, and a radially projecting counterweight 18, which is an arcuate portion extending through approximately 180° with respect to the axis.

The embodiment of the invention therefore provides a vibrating grid shaft assembly which no longer requires eccentric masses to be located externally or outboard of the screen frame sides. Furthermore, by locating the eccentric masses inboard, the problems of external rotating masses is avoided, while still providing an effective application of vibrational energy to the screen frame sides.

Also, although movement of the eccentric masses from externally to inboard may involve some risk of angular misalignment problems arising, it has been found in practice that these can be kept to a reasonable minimum, and no excessive heating of the bearings takes place.

Running tests carried out on the embodiment illustrated in the drawings have shown that the assembly can work satisfactorily for prolonged periods, and without generation of excessive heat in the bearings and other components.

1. A vibrating grid shaft assembly for use in a screening plant having opposed screen frame sides and which comprises:
a shaft which is intended to extend between the frame sides;
stubshafts projecting from each end of the shaft, and each adapted to be mounted in or on a respective screen frame side;
a respective bearing mounted on each stubshaft and intended to be located inboard of the adjacent screen frame side, and defining a rotational axis for the shaft; and,
a respective load mounted eccentrically with respect to the rotational axis and incorporated within the shaft adjacent to each stubshaft and so as to be located inboard of the adjacent screen frame side.

2. A shaft assembly according to claim 1, in which a stationary protective tube surrounds the shaft and mounts the bearings in order to mount the shaft for rotation therein.

3. A shaft assembly according to claim 2, in which the protective tube is secured at each end to respective screen frame sides, to mount the vibrating grid shaft assembly in a screening plant.

4. A shaft assembly according to claim 1, in which each eccentric mass comprises a cylindrical portion mounted off-set with respect to the rotational axis of the shaft, and a radially projecting counterweight.

5. A shaft assembly according to claim 1, in which the bearings are roller bearings, mounted on the stubshafts at an axial location such that, when the shaft is mounted between the screen frame sides, each bearing is located closely adjacent to the respective screen frame sides.

6. A shaft assembly according to claim 1, in which one of the stubshafts projects to a greater extent, so that a hydraulic or other drive motor and associated coupling may be mounted thereon.

7. A screen box incorporating a vibrating grid shaft assembly according to claim 9.

8. (canceled).

9. A vibrating grid shaft assembly for use in a screening plant having opposed screen frame sides and which comprises:
a shaft which is intended to extend between the frame sides;
stubshafts projecting from each end of the shaft, and each adapted to be mounted in or on a respective screen frame side;
a respective bearing assembly mounted on each stubshaft and intended to be located inboard of the adjacent screen frame side, and defining a rotational axis for the shaft;
a respective load mounted eccentrically with respect to the rotational axis and incorporated within the shaft adjacent to each stubshaft and so as to be located inboard of the adjacent screen frame side; and
a stationary protective tube which surrounds the shaft and in which the bearing assemblies are mounted, said tube being securable at each end to respective screen frame sides, to mount the vibrating grid shaft assembly in a screening plant and for the transmission of vibration energy to the screen frame sides.

10. A shaft assembly according to 9, in which each load comprises a cylindrical portion mounted off-set with respect to the rotational axis of the shaft, and a radially projecting counterweight.

11. A shaft assembly according to claim 9, in which each bearing assembly includes roller bearings which are mounted on the stubshafts at an axial location such that, when the shaft is mounted between the screen frame sides, each roller bearing is located closely adjacent to the respective screen frame side.

12. A shaft assembly according to claim 11, in which one of the stubshafts projects to a greater extend, so that the hydraulic or other drive motor and associated coupling may be mounted thereon.
